(19) United States
(12) Patent Application Publication
(10) Pub. No.: US 2008/0020778 A1
(43) Pub. Date: Jan. 24, 2008

(54) METHOD FOR EFFICIENT PERSISTENT RESOURCE ASSIGNMENT IN COMMUNICATION SYSTEMS

(75) Inventor: Zhouyue Pi, Richardson, TX (US)

Correspondence Address: TIMOTHY F. BLISS, P.O. BOX 793968, DALLAS, TX, 75379-3968, US

(73) Assignee: Samsung Electronics Co., Ltd., Suwon-city (KR)

(21) Appl. No.: 11/765,780

(22) Filed: Jun. 20, 2007

Related U.S. Application Data
(60) Provisional application No. 60/831,913, filed on Jul. 19, 2006.

(51) Int. Cl. H04Q 7/20

(52) U.S. Cl. 455/450

(57) ABSTRACT

The present disclosure relates generally to methods for persistent resource assignment. In one example, the method includes allocating a communication resource set containing resource units to multiple user groups. A starting resource unit and a direction are assigned to at least two user groups, where each user group is to consume resource units beginning with a resource unit identified by a position of the assigned starting resource unit and is to only consume additional resource units that are located in the assigned direction relative to the starting resource unit.

### CLAIM OF PRIORITY

This application claims priority from U.S. Provisional Patent Application No. 60/831,913, entitled “METHODS AND APPARATUS FOR EFFICIENT PERSISTENT RESOURCE ASSIGNMENT IN OFDMA SYSTEMS”, filed on Jul. 19, 2006, which is incorporated herein by reference in its entirety.

### BACKGROUND

In communications systems, resource allocation may be used to assign system resources to a user or a group of users. Depending on the communication system, allocated resources may include frequency bandwidth, time domain transmission units, and/or power. The allocation of such resources, which may be dynamic or persistent, may involve allocating a particular frequency to a particular user at a particular time and may define an amount of power to be used for the allocated time-frequency resources. However, current resource allocation approaches need improvement. For example, when a relatively large number of users are scheduled simultaneously, resource allocation may be quite complex. Furthermore, the signaling of the resource allocation to users may also incur significant overhead that can consume many of the allocated resources, resulting in few resources remaining for actual communication. Accordingly, improved methods of allocating resources to multiple user are needed.

### SUMMARY

In one embodiment, a method comprises allocating a communication resource set containing a plurality of resource units to a plurality of user groups. A first starting resource unit and a first direction are assigned to a first user group of the plurality of user groups, wherein the first user group is to consume resource units from the communication resource set beginning with a resource unit identified by a position of the first starting resource unit in the communication resource set and is to only consume additional resource units that are located in the first direction relative to the first starting resource unit. A second starting resource unit and a second direction that is opposite to the first direction are assigned to a second user group of the plurality of user groups, wherein the second user group is to consume resource units from the communication resource set beginning with a resource unit identified by a position of the second starting resource unit in the communication resource set and is to only consume additional resource units that are located in the second direction relative to the second starting resource unit.

In another embodiment, a method comprises identifying a communication resource set containing a plurality of resource units to be allocated to a plurality of user groups. At least a portion of the plurality of resource units are implicitly assigned to a first user group of the plurality of user groups, wherein the implicit assignment includes assigning a first starting resource unit and a first direction to the first user group, wherein the first starting resource unit defines a first resource unit to be used by the first user group prior to using other resource units, and wherein the first direction defines a position of other resource units to be used relative to the first starting resource unit. At least a portion of the plurality of resource units are implicitly assigned to a second user group of the plurality of user groups, wherein the implicit assignment includes assigning a second starting resource unit and a second direction to the second user group, wherein the second starting resource unit defines a second resource unit to be used by the second user group prior to using other resource units, and wherein the second direction defines a position of other resource units to be used relative to the second starting resource unit.

In yet another embodiment, a method comprises allocating a first subset of resource units to first and second communication groups, wherein resource units within the first subset are sequentially ordered. The first communication group is signaled to consume resource units from the first subset based on a relative position of a first starting resource unit in the first subset and a first direction, wherein the first direction indicates movement from the first starting resource unit through the resource units of the first subset based on the sequential order. The second communication group is signaled to consume resource units from the first subset based on a relative position of a second starting resource unit in the first subset and a second direction that is opposite the first direction, wherein the second direction indicates movement from the second starting resource unit towards the first starting unit through the resource units of the first subset based on the sequential order.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates an example of bit map signaling.

FIG. 2 is a flowchart illustrating one embodiment of a method for persistent resource allocation in a communications system.

FIG. 3 illustrates one embodiment of persistent resource allocation to two groups of users in a communications system.

FIG. 4 illustrates one embodiment of persistent resource allocation to multiple groups of users in a communications system.

FIG. 5 illustrates one embodiment of persistent resource allocation using a dynamically assigned common starting resource unit.

FIG. 6 illustrates one embodiment of persistent resource allocation using multiple dynamically assigned common starting resource units.

FIG. 7 is a block diagram of one embodiment of a network within which persistent resource allocation may be implemented.

### DETAILED DESCRIPTION

It is to be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

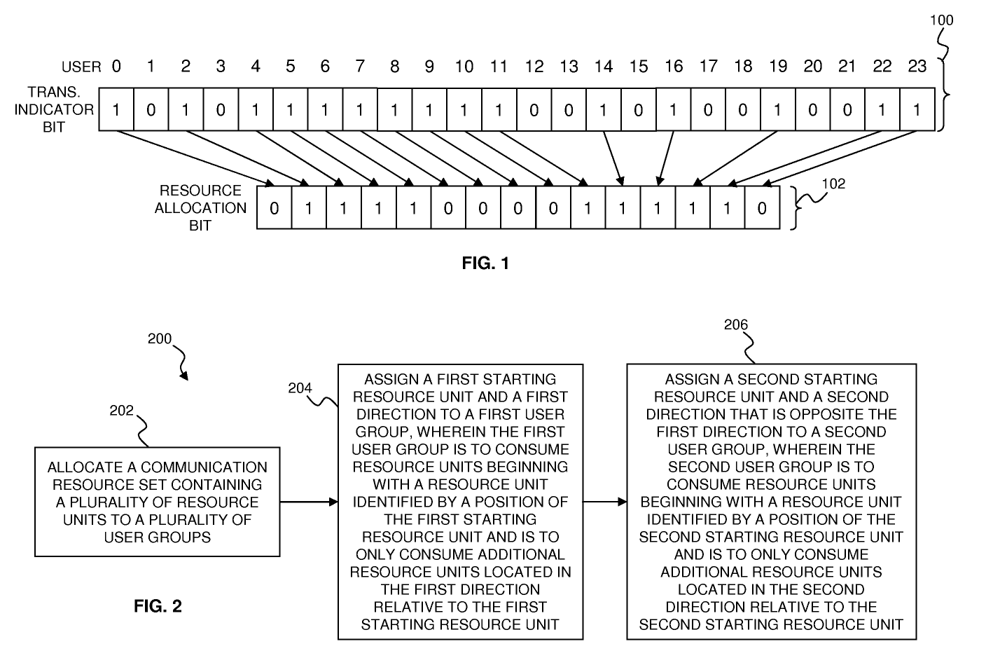

Referring to FIG. 1, bit maps 100 and 102 illustrate one embodiment of bit map signaling that may be used with persistent resource allocation to assign system resources to a user or a group of users. One example of persistent resource allocation is described in the 3GPP2 (3rd Generation Partnership Project 2) DO Rev. C (now renamed Ultra Mobile Broadband) framework proposal, which allows resources to be persistently allocated to a user or a group of users to reduce control overhead. This type of persistent resource allocation may be used, for example, to assign resources to a Voice over Internet Protocol (VoIP) group. In this case, multiple VoIP users may be grouped together and the group may be assigned a set of time-frequency resources to be shared by the VoIP users in the group. Bit map based signaling may be used to communicate the resource allocation within the group. In the present example, persistent resource assignment for a VoIP group is generally more efficient than persistent resource assignment for individual VoIP users because of statistical multiplexing between users within the group.

In FIG. 1, the bit maps 100 and 102 are associated with a group of twenty-four users. For purposes of illustration, the users are VoIP users, but it is understood that the bit maps 100 and 102 may be associated with other communication technologies. The bit map 100 includes twenty-four transmission indicator bits that correspond to each of the twenty-four users 0-23. Each bit indicates whether there is a transmission for its corresponding user. The bit map 102 represents resource allocation to users for which there is a transmission.

More specifically, at any slot or frame, the bit map 100 indicates whether transmission to each user is present. For example, the value at bit position 0 is “1”, which means there is a transmission for user 0 in this slot or frame, the value at bit position 1 is “0”, which means there is not a transmission for user 1 in this slot or frame, the value at bit position 2 is “1”, which means there is a transmission for user 2 in this slot or frame, and the value at bit position 3 is “0”, which means there is not a transmission for user 3 in this slot or frame.

The bit map 102 is used to signal the amount of resources allocated to the active users (i.e., users represented by a “1” value in bit map 100). While the present embodiment includes values of “0” and “1” (representing one and two resources, respectively) for the resource allocation bits, it is understood that additional resources may be allocated in other embodiments using, for example, additional bits for each active user. In the present example, user 0 is the first active user in the group, and the value of “0” at the first bit position of the bit map 102 means that one resource unit is assigned to user 0. User 2 is the second active user, and the value of “1” at the second bit position of the bit map 102 means that two resource units are assigned to user 2. Similarly, user 4 is the third active user in the group, and the value of “1” at the third bit position of the bit map 102 means that two resource units are assigned to user 4. Accordingly, an access network associated with the user group may assign channel resources to the active users based on the bit map 102. It is understood that the bit map 102 may be arranged represent inactive users (i.e., users represented by a “0” value in bit map 100) in some embodiments.

One challenge of the bit map design approach illustrated in FIG. 1 is the tradeoff that occurs between the amount of statistical multiplexing gain and the bit map overhead. Statistical multiplexing allows link sharing in communications systems by dividing a fixed bandwidth communication channel into several variable bit-rate digital channels. The link sharing may be adjusted to address the instantaneous traffic demands of data streams that are transferred over each channel. Such statistical multiplexing may improve link utilization, denoting the statistical multiplexing gain. Bit map overhead may include factors such as the memory footprint and processing needed to maintain a bit map, as well as the bandwidth needed to transmit the bit map to users. To maximize the statistical multiplexing gain, it may be beneficial to include all the VoIP users in one group. However, with many users, a bit map associated with the users may become relatively large (e.g., the bit map overhead is increased). Because the bit map has to be correctly received before a user can determine its resource allocation and receive its packet, the error probability of the bit map should be low, even for the user with the worst channel condition. Accordingly, a large bit map generally results in increased bit map overhead that may minimize or negate the benefit of including all VoIP users in a single group.

Another drawback of the bit map design approach illustrated in FIG. 1 is resource fragmentation. Generally, each VoIP group may be assigned a set of resources and not all of the resources assigned to a group may be used at a given time. Accordingly, to promote efficiency, the resources should be temporarily re-assigned to other users or groups when they are not utilized by the assigned group. If there are multiple VoIP groups that each has a small fraction of unused resources, the left-over resources may become fragmented and assigning them to other users or groups becomes more complex.

Referring to FIG. 2, in one embodiment, a method 200 may address the above issues by more efficiently allocating resources to a group of users. The method 200 begins in step 202 by allocating a set of resources (e.g., VoIP resources) containing multiple resource units to multiple user groups. A user group may have one or more users and, in some embodiments, may have zero users. A resource unit may be any type and amount of a resource that can be allocated to a user group, such as a channel or a portion of a channel.

In step 204, a starting resource unit and a direction are assigned to one of the user groups. The user group to which the starting resource unit and direction are assigned is to consume resources beginning with a resource unit identified by a position of the starting resource unit within the resource set and is to only consume additional resource units (if needed) based on the assigned direction. It is understood that the resource units may not be in sequential order, but may be in some ordered arrangement that allows a direction to be established.

In step 206, a starting resource unit and a direction are assigned to another one of the user groups, which is to consume resource units beginning with a resource unit identified by a position of the starting resource unit within the resource set and is to only consume additional resource units (if needed) based on the assigned direction. In the present embodiment, the two assigned directions are opposite one another, so one group will move in one direction (e.g., forward towards the other group) and the other group will move in the opposite direction (e.g., backwards towards the other group).

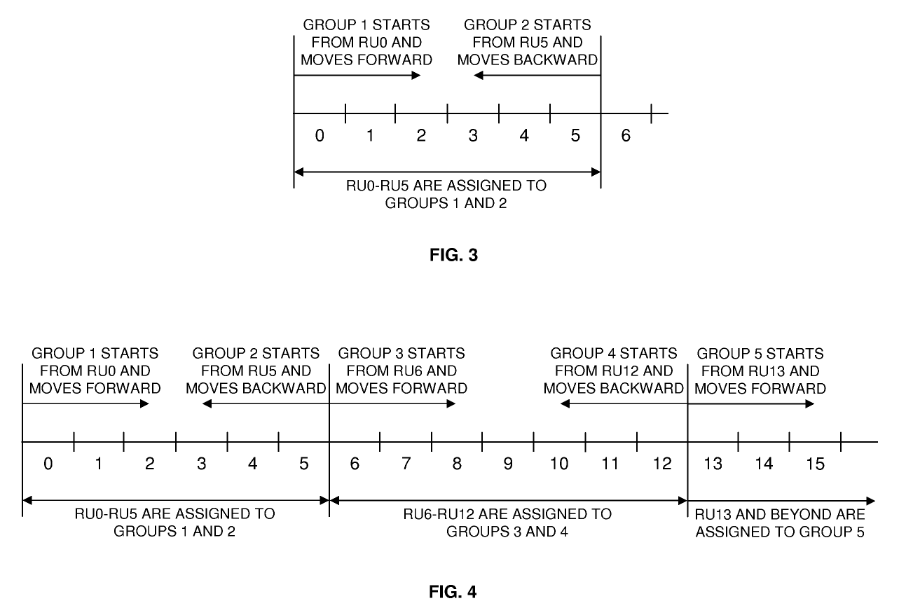

With additional reference to FIG. 3, in one embodiment, method 200 of FIG. 2 may be applied to allocate resource units (RUs) 0-5. It is understood that, although the resource units 0-5 are illustrated sequential order, the resource units 0-5 (RU0-RU5) may not be in sequential order in some embodiments, but may be in other ordered arrangements that allow “first” and “last” resource units to be defined. The resource units 0-5 may be assigned to multiple user Groups 1 and 2 (e.g., groups of VoIP users). In the present example, the resource units 0-5 are assigned to both Group 1 and Group 2.

In order for Groups 1 and 2 to share resource units 0-5, Group 1 is directed to use the resource units starting from RU0 and moving forward, while Group 2 is directed to use the resource units starting from RU6 and moving backward. In this example, the starting resource unit may be excluded when resource utilization moves backwards (e.g., Group 2 is assigned a starting resource unit of RU6, but begins by using RU5). In other embodiments, the starting resource unit may be included when resource utilization moves backward (e.g., Group 2 may be assigned a starting resource unit of RU5).

With the resource unit allocation illustrated in FIG. 3, the statistical multiplexing gain may be similar or identical to the situation where all users in Group 1 and Group 2 are in a single group. However, the signaling overhead is the same as having two smaller groups. Accordingly, both the statistical multiplexing gain and the signaling overhead may benefit from the approach illustrated in FIG. 3.

Referring to FIG. 4, in another embodiment, resource units 0-15 may be shared implicitly among multiple user Groups 1-5. For purposes of illustration, RU0-RU5 may be used for Groups 1 and 2, RU6-RU12 may be used for Groups 3 and 4, and RU13 and beyond may be used for Group 5. In the present example, a starting resource unit and a direction may be assigned to each of the Groups 1-5 to implicitly allocate resource units to each group.

Accordingly, Group 1 may be assigned a starting resource unit=“RU0” and a direction=“Forward”. Based on this assignment, Group 1 will begin consuming resources at RU0 and will then move forward (e.g., to the right of RU0 in FIG. 4) to other resource units up to and including RU5 (assuming those resource units are needed by Group 1 and have not been used by Group 2). So if Group 1 needs three resource units for transmission, it will use RU0, RU1, and RU2.

Group 2 may be assigned a starting resource unit=“RU6” and a direction=“Backward”. Accordingly, Group 2 will begin consuming resources at RU5 and then move backward (e.g., to the left of RU5 in FIG. 4) to other resource units down to and including RU0 (assuming those resource units are needed by Group 2 and have not been used by Group 1). So if Group 2 needs two resource units for transmission, it will use RU5 and RU4.

In this case, RU0-RU5 are shared by Group 1 and Group 2, although the assignment is implicit (e.g., each Group is simply given a starting resource unit and a direction, rather than being explicitly assigned RU0-RU5). It is noted that if Group 1 is instructed to always start from a certain resource unit (e.g., RU0) and move forward, then no resource assignment signaling overhead is needed for Group 1. Similarly, if Group 2 is instructed to always start from a certain resource unit (e.g., RU5) and move backward, then no resource assignment signaling overhead is needed for Group 2.

In a similar manner, Group 3 may be assigned a starting resource unit=“RU6” and a direction=“Forward”. Accordingly, Group 3 will begin consuming resources at RU6 and will then move forward to other resource units. Group 4 may be assigned a starting resource unit=“RU13” and a direction=“Backward”. Accordingly, Group 4 will begin consuming resources at RU12 and then move backward to other resource units. As with Groups 1 and 2, if Group 3 is instructed to always start from certain resource unit and move forward, then no resource assignment signaling overhead is needed for Group 3. Similarly, if Group 4 is instructed to always start from a certain resource unit and move backward, then no resource assignment signaling overhead is needed for Group 4.

In the present example, Group 5 is assigned the remaining resources RU13 and beyond. Accordingly, Group 5 may be assigned a starting resource unit=“RU13” and a direction=“Forward”. Group 5 will begin consuming resources at RU13 and will then move forward to other resource units. It is understood that a Group 6 (not shown) may exist and would move backward from an assigned starting resource unit towards RU13. This implicit assignment procedure may be used to allocate resource units to many different groups and may be used to tailor the allocation to the needs of each particular group.

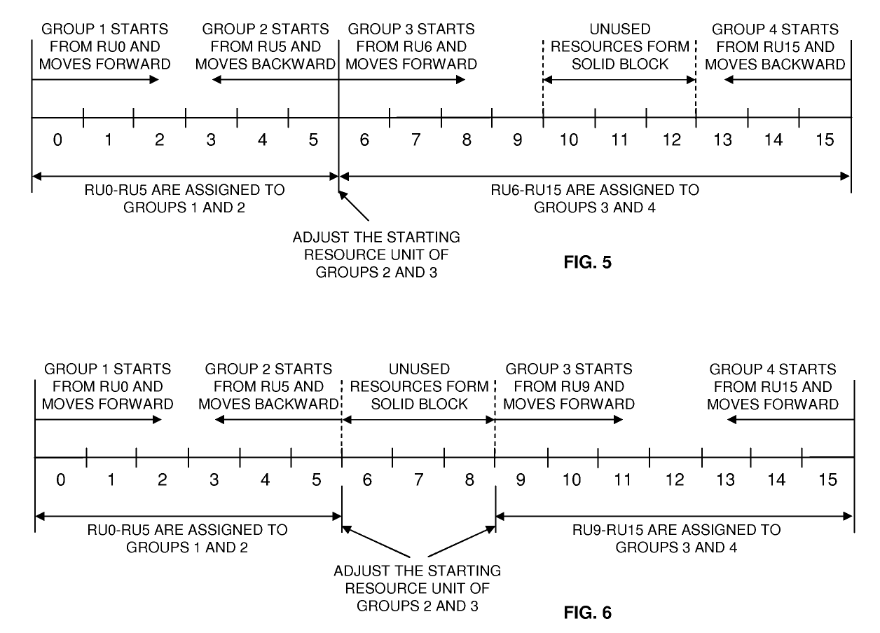

Referring to FIG. 5, in yet another embodiment, a common starting resource unit may be assigned to two groups and dynamically adjusted to further remove resource fragmentation. In FIG. 5, resource units 0-15 may be shared among multiple user Groups 1-4, with a starting resource unit and a direction assigned to each of the Groups 1-4.

As described previously with respect to FIG. 4, Group 1 may be assigned a starting resource unit=“RU0” and a direction=“Forward”. Accordingly, Group 1 will begin consuming resources at RU0 and will then move forward to other resource units. Group 4 may be assigned a starting resource unit=“RU16” and a direction=“Backward”. Accordingly, Group 4 will begin consuming resources at RU15 and then move backward to other resource units.

In order to minimize or eliminate fragmentation, a common starting resource unit may be assigned to multiple groups and dynamically adjusted in an attempt to maintain a block of unused resource units. For example, a common starting resource unit RU6 may be dynamically assigned to both Group 2 and Group 3. As described previously, Group 2 may begin resource consumption at the resource unit to the left of the assigned starting resource unit. In addition, a resource utilization direction of “Backward” may be assigned to Group 2, and a resource utilization direction of “Forward” may be assigned to Group 3. In this case, resource fragmentation may be minimized or eliminated between Group 2 and Group 3.

Furthermore, the location of the common starting resource unit may be adjusted to minimize or eliminate resource fragments between multiple groups. For example, as shown in FIG. 5, for a particular transmission, if Group 1 uses three RUs (RU0-RU2) and Group 2 uses three RUs (RU5-RU7), the common starting resource unit of Group 2 and Group 3 may be assigned as RU6. In this case, there will be no resource fragments between Groups 1, 2, and 3. For a sector with four VoIP groups, as shown in FIG. 5, resource fragments may be completely removed using this dynamically assigned common starting resource unit and combined into a block of unused resources (e.g., RU10-RU12 in FIG. 5). As described previously, this block may provide advantages when allocating unused resource units to other groups. It is noted that the common starting resource unit RU6 need only to be signaled to users in Group 2 and Group 3.

Referring to FIG. 6, in still another embodiment, a starting resource unit may be dynamically adjusted for multiple groups to minimize or eliminate resource fragments. In FIG. 6, resource units 0-15 may be shared among multiple user Groups 1-4, with a starting resource unit and a direction assigned to each of the Groups 1-4.

As described previously with respect to FIG. 4, Group 1 may be assigned a starting resource unit=“RU0” and a direction=“Forward”. Accordingly, Group 1 will begin consuming resources at RU0 and will then move forward to other resource units. Group 4 may be assigned a starting resource unit=“RU16” and a direction=“Backward”. Accordingly, Group 4 will begin consuming resources at RU15 and then move backward to other resource units.

As shown in FIG. 6, resource fragmentation may be minimized or eliminated by adjusting the starting resource units for Group 2 and Group 3. In this case, the starting resource unit of Group 2 may be dynamically assigned to users in Group 2 and the starting resource unit of Group 3 may be dynamically assigned to users in Group 3. For example, a starting resource unit RU6 may be dynamically assigned to Group 2, and a starting resource unit RU9 may be dynamically assigned to Group 3. It is understood that, in some embodiments, the starting resource unit may be the same for Groups 2 and 3.

A block of unused resource units (e.g., RU6-RU8 in FIG. 6) may exist between the two starting resource units for Groups 2 and 3. In addition, a resource utilization direction of “Backward” may be assigned to Group 2, and a resource utilization direction of “Forward” may be assigned to Group 3. Dynamic assignment of the starting resource unit (and direction if not already assigned) to Group 2 may be used to minimize or eliminate resource fragmentation between Groups 1 and 2, and dynamic assignment of the starting resource unit (and direction if not already assigned) to Group 3 may be used to minimize or eliminate resource fragmentation between Groups 3 and 4.

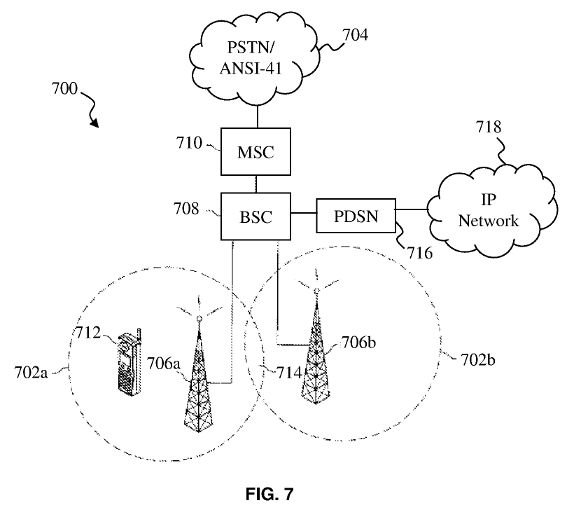

Referring to FIG. 7, a communications network 700 illustrates one embodiment of a system in which resource unit assignment as described herein may be performed. In the present example, the network 700 is an Orthogonal Frequency Division Multiple Access (OFDMA) network that may be compatible with a variety of standards including, but not limited to, 3GPP2 Ultra Mobile Broadband (UMB), 3GPP Long Term Evolution (LTE or Release 8), and mobile WiMax systems. The network 700 may represent other technologies, including Global System for Mobile communication (GSM) and Code Division Multiple Access (CDMA). It is understood that the methods of the present disclosure may be performed in networks based on different technologies, and that the examples using an OFDMA network are for purposes of illustration only.

The network 700 comprises a plurality of cells 702a, 702b. In the present example, the network 700 is a wireless network, and may be coupled to other wireless and/or wireline networks, such as a Public Switched Telephone Network (PSTN) 704. Each cell 702a, 702b in the network 700 may include a base transceiver station (BTS) 706a, 706b, respectively, which may be coupled to a base station controller (BSC) 708. A mobile switching center (MSC) 710 may be used to couple the network 700 with other networks such as the PSTN 704. The BSC 708 may also be coupled to a PDSN 716 that is in turn coupled to an IP network 718, such as the Internet.

The network 700 enables a mobile device 712 to communicate with another device (not shown) via the BTS 706a associated with the cell 702a in which the mobile device is located. Although illustrated as a cellular telephone in the present example, the mobile device 712 may be any device capable of receiving, processing, and/or transmitting communications, including pagers, cellular telephones, personal digital assistants, and computers.

In some embodiments, the cells 702a, 702b may overlap so that the mobile device 712 may travel from one cell to another (e.g., from the cell 702a to the cell 702b) while maintaining a communication session. In a “handoff” region 714 (e.g., the area where the cells 702a, 702b overlap), the mobile device 712 may be serviced by both the BTS 706a and the BTS 706b. It is understood that the mobile device 712 may participate in many different types of communication sessions, including voice calls, data transfer, and/or VoIP calls.

Although not shown, it is understood that some or all entities of the network 700 may include one or more processors, memories, and other components that enable the entities to receive, store, retrieve, process, and transmit instructions and data over wireless and/or wireline communication links. Furthermore, at least some functionality of an entity may be distributed and located elsewhere, either within a cell or outside of a cell. Repeaters (not shown) may be used to extend the range of the BTS 706a and/or 706b.

Other technologies to which the aspects of the present disclosure may be applied to other technologies, such as may be used in WirelessMAN (wireless metropolitan area network) and Wireless Regional Area Networks (under IEEE 802.22). As is known, WirelessMAN, which is being developed pursuant to the IEEE 802.16 Working Group on Broadband Wireless Access Standards, defines broadband Internet access from fixed or mobile devices via antennas. In WirelessMAN systems, subscriber stations communicate with base-stations that are connected to a core network. OFDMA is used in the mobility mode of WirelessMAN and provides multiple access in such systems by assigning subsets of subcarriers to individual users, thereby allowing simultaneous data transmission to and from several users.

Although the preceding embodiments describe persistent assignment for VoIP groups in the context of a system such as that defined in the 3GPP2 DO Rev. C (UMB) framework proposal, it is understood the present disclosure may be applied to many other types of multiple access systems, other types of groups and/or individual users, other types of persistent or non-persistent resource assignments scenarios, and other types of resources using forward link and/or reverse links. Accordingly, although only a few exemplary embodiments of this disclosure have been described in details above, those skilled in the art will readily appreciate that many modifications are possible in the exemplary embodiments without materially departing from the novel teachings and advantages of this disclosure. Also, features illustrated and discussed above with respect to some embodiments can be combined with features illustrated and discussed above with respect to other embodiments. Accordingly, all such modifications are intended to be included within the scope of this disclosure.

1. A method comprising:
allocating a communication resource set containing a plurality of resource units to a plurality of user groups;
assigning a first starting resource unit and a first direction to a first user group of the plurality of user groups, wherein the first user group is to consume resource units from the communication resource set beginning with a resource unit identified by a position of the first starting resource unit in the communication resource set and is to only consume additional resource units that are located in the first direction relative to the first starting resource unit; and
assigning a second starting resource unit and a second direction that is opposite to the first direction to a second user group of the plurality of user groups, wherein the second user group is to consume resource units from the communication resource set beginning with a resource unit identified by a position of the second starting resource unit in the communication resource set and is to only consume additional resource units that are located in the second direction relative to the second starting resource unit.

2. The method of claim 1 wherein the first and second directions are forward and backward, respectively.

3. The method of claim 2 wherein the first starting resource unit is positioned in front of the second starting resource unit in the communication resource set.

4. The method of claim 3 further comprising assigning a third starting resource unit and a third direction to a third user group of the plurality of user groups, wherein the third user group is to consume resource units from the communication resource set beginning with a resource unit identified by a position of the third starting resource unit in the communication resource set and is to only consume additional resource units that are located in the first direction relative to the third starting resource unit.

5. The method of claim 4 wherein the third starting resource unit is positioned after the second starting resource unit in the communication resource set.

6. The method of claim 1 wherein the resource unit identified by the position of the first starting resource unit is the first starting resource unit.

7. The method of claim 1 wherein the resource unit identified by the position of the second starting resource unit is located in the second direction relative to the second starting resource unit.

8. The method of claim 7 wherein the resource unit identified by the position of the second starting resource unit is offset from the second starting resource unit by one position in the second direction.

9. The method of claim 1 wherein the second starting resource unit is dynamically assigned based on resource unit needs of at least the second user group.

10. A method comprising:
identifying a communication resource set containing a plurality of resource units to be allocated to a plurality of user groups;
implicitly assigning at least a portion of the plurality of resource units to a first user group of the plurality of user groups, wherein the implicitly assigning includes assigning a first starting resource unit and a first direction to the first user group, wherein the first starting resource unit defines a first resource unit to be used by the first user group prior to using other resource units, and wherein the first direction defines a position of other resource units to be used relative to the first starting resource unit; and
implicitly assigning at least a portion of the plurality of resource units to a second user group of the plurality of user groups, wherein the implicitly assigning includes assigning a second starting resource unit and a second direction to the second user group, wherein the second starting resource unit defines a second resource unit to be used by the second user group prior to using other resource units, and wherein the second direction defines a position of other resource units to be used relative to the second starting resource unit.

11. The method of claim 10 further comprising implicitly assigning at least a portion of the plurality of resource units to a third user group of the plurality of user groups, wherein the implicitly assigning includes assigning a third starting resource unit and the first direction to the third user group, wherein the third starting resource unit defines a third resource unit to be used by the third user group prior to using other resource units, and wherein the first direction defines a position of other resource units to be used relative to the third resource unit.

12. The method of claim 11 wherein the second and third starting resource units are adjacent in the communication resource set.

13. The method of claim 11 wherein the second and third starting resource units are a common starting resource unit.

14. The method of claim 13 wherein the common starting resource unit is dynamically assigned based on a resource unit usage of at least the second user group.

15. The method of claim 12 further comprising implicitly assigning at least a portion of the plurality of resource units to a fourth user group of the plurality of user groups, wherein the implicitly assigning includes assigning a fourth starting resource unit and the second direction to the fourth user group, wherein the fourth starting resource unit defines a fourth resource unit to be used by the fourth user group prior to using other resource units, and wherein the second direction defines a position of other resource units to be used relative to the fourth resource unit.

16. The method of claim 15 wherein the third and fourth resource units are separated by a contiguous block of unused resource units of the communication resource set.

17. The method of claim 16 wherein at least one of the second and third starting resource units is dynamically assigned based on a resource unit usage of the second and third user groups, respectively.

18. A method comprising:
allocating a first subset of resource units to first and second communication groups, wherein resource units within the first subset are sequentially ordered;
signaling the first communication group to consume resource units from the first subset based on a relative position of a first starting resource unit in the first subset and a first direction, wherein the first direction indicates movement from the first starting resource unit through the resource units of the first subset based on the sequential order; and
signaling the second communication group to consume resource units from the first subset based on a relative position of a second starting resource unit in the first subset and a second direction that is opposite the first direction, wherein the second direction indicates movement from the second starting resource unit towards the first starting unit through the resource units of the first subset based on the sequential order.

19. The method of claim 18 further comprising:
allocating a second subset of resource units to a third communication group, wherein resource units within the second subset are sequentially ordered relative to the sequential order of the first subset; and
signaling the third communication group to consume resource units from the second subset based on a relative position of a third starting resource unit in the second subset and the first direction, wherein the first direction indicates movement from the third starting resource unit away from the first and second starting resource units through the resource units of the second subset based on the sequential order.

20. The method of claim 19 wherein at least one of the second and third starting resource units is dynamically assigned based on a resource unit usage of the second and third communication groups, respectively.

21. A transmission apparatus comprising:
an antenna;
a processor coupled to the antenna and configured to transmit signals via the antenna; and
a memory coupled to the processor for storing instructions executable by the processor, the instructions including instructions for:
allocating a first subset of resource units to first and second communication groups, wherein resource units within the first subset are sequentially ordered;
signaling the first communication group to consume resource units from the first subset based on a relative position of a first starting resource unit in the first subset and a first direction, wherein the first direction indicates movement from the first starting resource unit through the resource units of the first subset based on the sequential order; and
signaling the second communication group to consume resource units from the first subset based on a relative position of a second starting resource unit in the first subset and a second direction that is opposite the first direction, wherein the second direction indicates movement from the second starting resource unit towards the first starting unit through the resource units of the first subset based on the sequential order.

22. The transmission apparatus of claim 21 wherein the transmission apparatus is a base station.

23. The transmission apparatus of claim 21 wherein the instructions further include instructions for:
allocating a second subset of resource units to a third communication group, wherein resource units within the second subset are sequentially ordered relative to the sequential order of the first subset; and
signaling the third communication group to consume resource units from the second subset based on a relative position of a third starting resource unit in the second subset and the first direction, wherein the first direction indicates movement from the third starting resource unit away from the first and second starting resource units through the resource units of the second subset based on the sequential order.

24. A method for use by a mobile device comprising:
receiving a resource allocation from a wireless network, wherein the resource allocation identifies a starting resource unit of a resource group to which the mobile device is assigned;
selecting a first resource unit from the resource group, wherein the first resource unit is located at a defined location in a defined direction from the starting resource unit within the resource group; and
using the first resource unit.

25. The method of claim 24 further comprising:
selecting a second resource unit for use from the resource group, wherein the second resource unit is located in a defined direction from the first resource unit within the resource group and wherein the mobile station only consumes resource units located in the defined direction relative to the first resource unit; and
using the second resource unit.

26. The method of claim 24 wherein the starting resource unit and the first resource unit are the same resource unit.

27. The method of claim 24 further comprising receiving the defined direction from the wireless network.

28. The method of claim 24 further comprising:
receiving a communication group assignment from the wireless network, wherein the communication group includes the mobile device; and
receiving an index of the mobile device within the communication group.

29. The method of claim 28 further comprising receiving the defined location from the wireless network.

30. The method of claim 29 wherein the defined location is indicated by a bitmap, wherein each bit of the bitmap indicates whether a corresponding mobile device in the communication group consumes one or a plurality of the resource units of the resource group

31. The method of claim 30 further comprising:
calculating an offset by adding the number of resource units consumed by mobile devices within the communication group with indices smaller than the index of the mobile device; and
calculating the defined location by adding the offset to the starting resource unit along the defined direction.

32. The method of claim 24 wherein the defined direction represents either forward or backward.

33. The method of claim 24 wherein the resource group is a sequential block of resources.

34. The method of claim 24 wherein the resource group is a non-sequential block of resources having the starting resource unit and a defined last resource unit.

35. The method of claim 24 wherein selecting the second resource unit for use from the resource group occurs by moving sequentially through the resource group and selecting the next available resource unit.

36. The method of claim 24 wherein selecting the second resource unit for use from the resource group occurs by moving non-sequentially through the resource group and selecting the next available resource unit.

37. The method of claim 24 further comprising receiving an updated resource allocation from the wireless network and dynamically updating the starting resource unit based on the updated resource allocation.

38. A reception apparatus comprising:
a processor configured to transmit signals to and receive signals from a wireless network via an antenna; and
a memory coupled to the processor for storing instructions executable by the processor, the instructions including instructions for:
receiving a resource allocation from a wireless network, wherein the resource allocation identifies a starting resource unit of a resource group to which the reception apparatus is assigned;
using a first resource unit from the resource group;
moving in a defined direction within the resource group to select a second resource unit, wherein the mobile station only consumes resource units located in the defined direction relative to the first resource unit; and
using the second resource unit.

39. The reception apparatus of claim 33 wherein the reception apparatus is a mobile wireless device.

40. The reception apparatus of claim 33 further comprising instructions for receiving the defined direction from the wireless network.

41. The reception apparatus of claim 33 wherein moving in the defined direction within the resource group occurs sequentially with respect to resource units within the resource group.

42. The reception apparatus of claim 33 wherein moving in the defined direction within the resource group occurs non-sequentially with respect to resource units within the resource group.
